(19) United States
(12) Patent Application Publication
(10) Pub. No.: US 2005/0272381 A1
(43) Pub. Date: Dec. 8, 2005

(54) Automatic wireless efm channel hopping

(76) Inventor: Casimir Johan Crawley, Carmel, IN (US)

Correspondence Address: Joseph S Tripoli;Thomson Licensing Inc, PO Box 5312, Princeton, NJ, 08543-5312, US

(21) Appl. No.: 10/520,728

(22) PCT Filed: Jul. 7, 2003
(86) PCT No.: PCT/US03/21075

§ 371 Date: Jan. 9, 2005

Related U.S. Application Data
(60) Provisional application No. 60/394,516, filed on Jul. 9, 2002.

(51) Int. Cl. H04B 7/00

(52) U.S. Cl. 455/73; 455/260

(57) ABSTRACT

An apparatus includes a reception circuit with a frequency synthesizer, a decoder for digitally demodulating an audio file signal from the reception circuit, and a processor for initializing the decoder in response to a loss of a phase lock in the demodulating of the audio file signal and setting the frequency synthesizer at one of a plurality of frequencies to re-establish the phase lock in the demodulating of the audio file signal. The plurality of frequencies are 900 MHz range channel frequencies. Preferably, the plurality of frequencies are 905 MHz, 911 MHz, 917 MHz and 923 MHz. The decoder includes an eight-to-four modulation EFM digital decoder. Demodulating the audio file signal provides a digital audio stream conforming to an I2S audio format. The processor is preferably a microprocessor.

### FIELD OF THE INVENTION

The present invention relates generally to wireless communications, and more particularly to automatic wireless channel hopping.

### BACKGROUND OF THE INVENTION

Many consumers want to enjoy a vast collection of digital audio files stored on their PC by playing those audio files on an audio system. Users have already been transferring audio files from CD storage onto their personal computers. Playing audio files directly from an Internet web site through a personal computer to a home audio system permits using the computer's processing and storage capacity to allow increased play lists, as well as an organized library of digital music files using ID3 tag song data to display artist, album, song title and genre. Wireless transmission and reception between a personal computer and the audio system would permit a higher quality listening experience for a user.

Wireless transmitter and receiver techniques must be able to send CD-quality digital audio from the personal computer to the audio system. Active users of jukebox-managed personal computer content and Internet audio listeners seeking alternatives for listening to digital quality music files require a convenient connection between their personal computer and audio system. Continuous transmission and reception between the audio file source and the audio system is required for full user experience in listening to digital quality music files available from a personal computer or a network site.

Wireless transmissions systems have employed selectable carrier frequencies for sending and receiving signals. Often, a user must manually change the carrier frequency. In audio file transfers the transmitter and receiver boards will probably be remotely located and require the user to manually switch both the transmitter and receiver boards to different channel. Accordingly there is a need for a wireless system for audio file transfers that automatically select the wireless transmission channel in both the transmitter and receiver boards to provide a user with near seamless play of music.

### SUMMARY OF THE INVENTION

An apparatus includes a reception circuit with a frequency synthesizer, a decoder for digitally demodulating an audio file signal from the reception circuit, and a processor for initializing the decoder in response to a loss of a phase lock in the demodulating of the audio file signal and setting the frequency synthesizer at one of a plurality of frequencies to re-establish the phase lock in the demodulating of the audio file signal. The plurality of frequencies are 900 MHz range channel frequencies. Preferably, the plurality of frequencies are 905 MHz, 911 MHz, 917 MHz and 923 MHz. The decoder comprises an eight-to-four modulation EFM digital decoder. Demodulating the audio file signal provides a digital audio stream conforming to an I2S audio format. The processor is preferably a microprocessor.

A computer readable medium contains software instructions that, when executed by a processor, performs the steps of receiving a modulated audio file signal, demodulating the audio file signal to a digital audio stream, re-initializing the demodulating in response to a loss of a phase lock in the demodulating the audio file signal, and setting the receiving at one of a plurality of channel frequencies to establish the phase lock in the demodulating.

A communications system includes a remote control reception circuit, a streaming controller coupled to the remote control reception circuit, an encoder for converting digital audio from the controller to a modulated data signal, a transmission circuit for transmitting the modulated data signal at one of a plurality of channel frequencies selected in response to the remote control reception circuit, reception circuit including a frequency synthesizer for receiving the modulated data signal, a demodulator coupled to the receiver for demodulating the modulated data signal, and a processor for initializing the demodulator in response to a loss of a phase lock in the demodulating of the modulated data signal and setting the frequency synthesizer at the one of a plurality of channel frequencies until the phase lock in the demodulating is established.

An apparatus includes a streaming controller for providing digital audio, an encoder for converting the digital audio to a modulated data signal, and a transmission circuit for transmitting the modulated data signal at one of a plurality of channel frequencies. The transmission circuit is preferably coupled to the encoder and the streaming controller.

### BRIEF DESCRIPTION OF THE DRAWINGS

A more complete understanding of the present invention may be obtained from consideration of the following description in conjunction with the drawings, in which:

FIG. 1 depicts an exemplary communications environment including an Internet network, a computer a wireless transmitter, wireless receiver and an audio system.

FIG. 2 is a block diagram of an exemplary wireless transmitter in accordance with the invention

FIG. 3 is a block diagram of an exemplary wireless receiver in accordance with the invention; and

FIG. 4 is a flow chart of wireless channel hopping in accordance with the invention.

To facilitate understanding, identical reference numerals have been used, where possible, to designate identical elements that are common to the figures.

### DETAILED DESCRIPTION

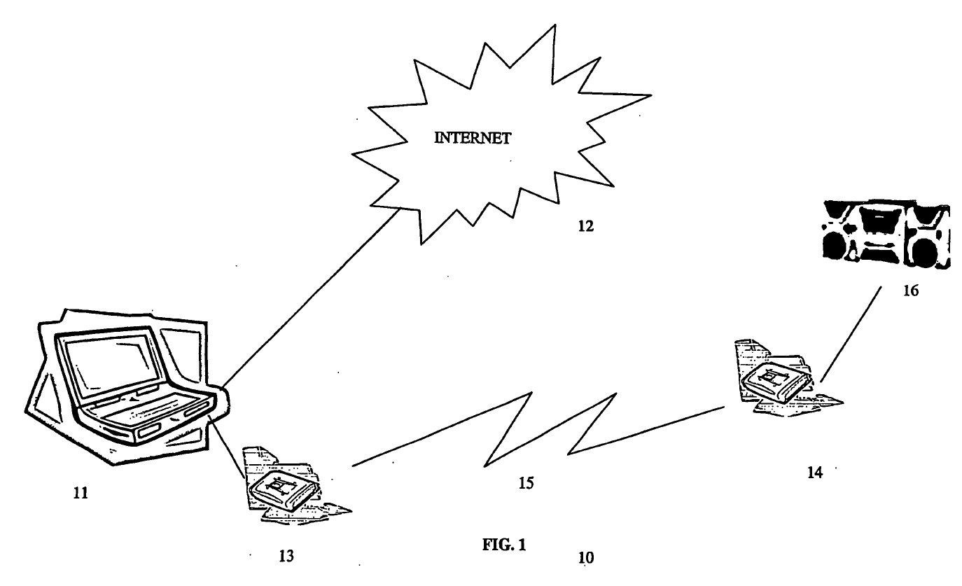

FIG. 1 depicts an exemplary communications environment 10 including an exemplary network 12, such as the Internet, a personal computer 11 with wireless transmitter 13, and a wireless receiver 14. The wireless transmitter 13 transfers audio files on the computer 11 to the wireless receiver 14 over wireless medium 15. The wireless receiver then sends the analog stereo signal to the audio system 16. The audio files can be any one of various file types, such as mp3, files stored for retention during shutoff of the computer or stored temporarily when the computer serves as a conduit for transmission of audio files from across the network to the wireless receiver 14. The transmitter 13 can be an integral component of the computer's architecture or an add-on device communicating with the computer through a port connection, such as a universal serial bus connection USB. The exemplary computer 11, shown as a laptop computer, can be a desktop computer system or a processor based device capable of relaying transfer of audio files from across a network to the wireless receiver 14.

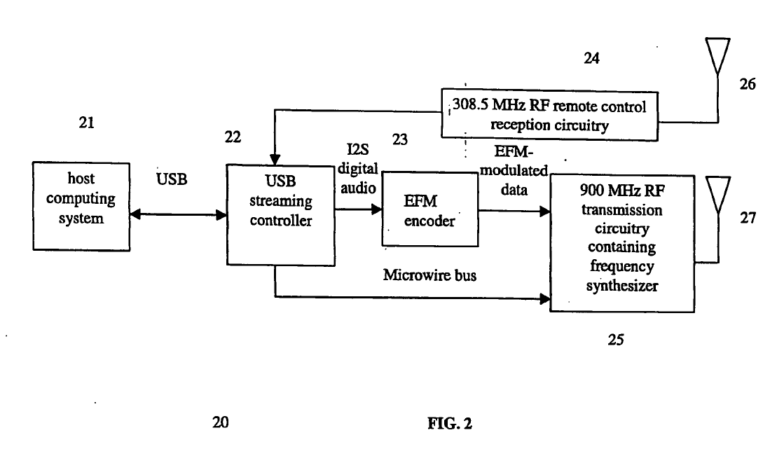

Referring to the block diagram of FIG. 2, there is shown an exemplary wireless transmitter 20 operable with an inventive channel hopping transmission. A host computing system 21 streams isochronous audio data over its universal serial bus USB port to a streaming controller 22 that streams this USB audio data as I2S digital audio into an eight-to-fourteen modulation EFM encoder 23. Eight-to-fourteen modulation EFM encoding is a known encoding technique for compact disk CD media encoding. The EPM encoder 23 encodes the I2S digital audio as EFM modulated data that is sent to a 900 MHz radio frequency RF transmission circuitry block 25. A user can choose a 905, 911, 917, or 923 MHz EFM transmission channel frequency with a radio frequency RF remote control (not shown). The RF remote control messages are picked up at an antenna 26 and received by a 308.5 MHz reception circuitry block 24 that outputs to the streaming controller 22. The streaming controller captures the demodulated RP messages, interprets these messages and programs the frequency synthesizer in the 900 MHz RF transmission circuitry block 25 with the desired channel frequency using the microwire bus. The EFM-modulated data is transmitted from the antenna 27 as a 900 MHz RF signal at a specific channel frequency chosen by the user.

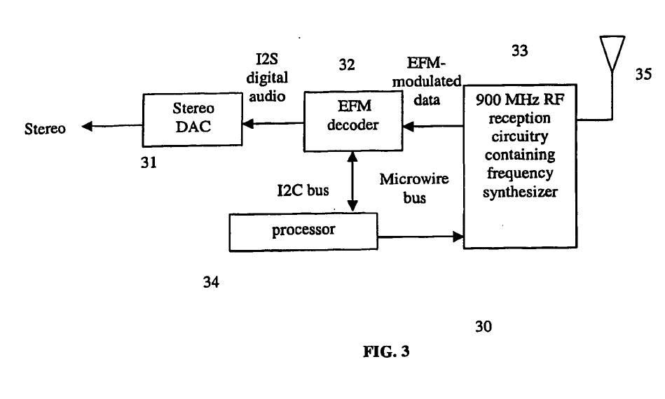

FIG. 3 is a block diagram 30 of an exemplary wireless receiver. An incoming modulated or encoded analog signal received at an antenna 35 is received into the reception circuitry board 33 containing a frequency synthesizer for synchronizing the receiver to an exemplary transmitter carrier frequency in the range of 900 MHz. The encoded signal is decoded by an eight-to-fourteen modulation decoder 32. A digital audio stream I2S from the decoder 32 is changed by the stereo digital-to-analog converter DAC 31 into an analog stereo input signal to an audio system. Communications protocols between the decoder 32 and processor 34 preferably conform to known I2C bus protocols. The processor is preferably a microprocessor tied over a microwire bus to the reception circuitry 33. The processor controls the frequency synthesizer for synchronizing the receiver to the radio carrier frequency of the audio file signal source transmitter. The processor 34 also carries out the inventive wireless audio file signal loss detection and resetting and initialization of the decoder 32 when a loss of the wireless audio file signal is detected.

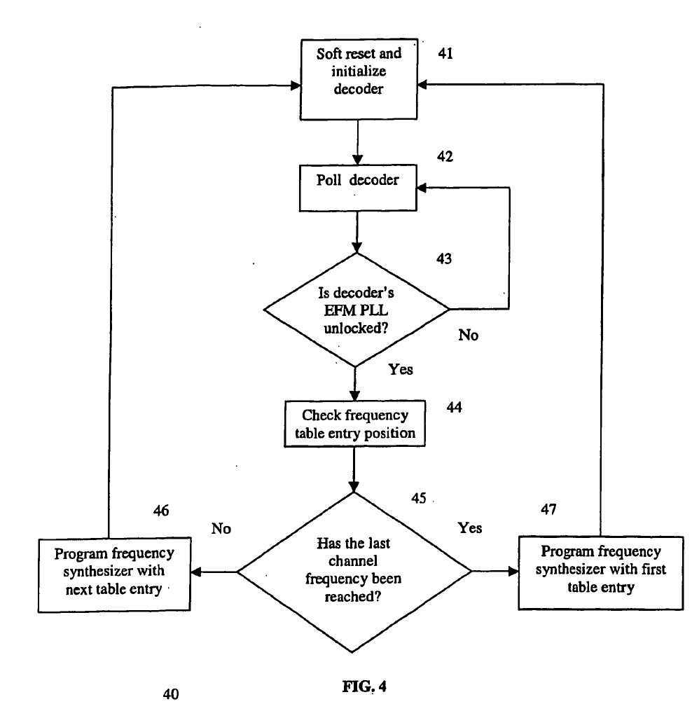

FIG. 4 is a flowchart 40 for the channel hopping selection and synchronizing between the transmitter 20 and receiver 30 circuits. Multiple carrier frequencies are available for selection as a channel frequency for transferring audio file from the transmitter to the receiver. Exemplary channel frequency values are 905 MHz, 911 MHz, 917 MHz and 923 MHz. The processor 34 first resets and initializes a phase lock loop condition in the decoder 32 for the audio file signal from the transmitter 41. The processor 34 then polls 42 the decoder 32 for a loss of phase lock condition in the phase lock loop PLL in the demodulation of the eight-to-fourteen modulation EFM audio file signal from the transmitter has been lost. If an unlocked phase condition in the phase lock loop during demodulation is detected 43, the processor checks the next frequency table entry position 44. If the position is at the end of the table corresponding to the last channel frequency value 45, then the processor programs the reception circuitry 33 with the first table entry, i.e., first channel frequency value. If the position is not at the end of the table corresponding to the last channel frequency value 45, then the processor programs the reception circuitry 33 with the next table entry, i.e., next channel frequency value. The processor 34 then re-initializes the decoder 32, 41.

The inventive channel hopping automatically initiated by detection of an unlocked condition in a phase lock loop PLL during demodulation of the transmitted/received audio signal provides additional user convenience. Transmitter and receiver board switches are eliminated leaving the user to enjoy near seamless listening of transmitted audio files. The user can change transmitter board channel frequency with a remote control or host system USB command. The receiver board then automatically selects the channel receiving EFM data by scanning all frequencies.

Although various embodiments which incorporate the teachings of the present invention have been shown and described in detail herein, those skilled in the art can readily devise many other varied embodiments that will still incorporate these teachings. The present invention has been described within the context of an audio system receiving transmission of audio files from a personal computer. It will be appreciated by those skilled in the art that the teachings of the present invention directed to automatic channel frequency hopping and selection may be practiced where the wireless signal is transmitting audio files stored on the computer or audio files downloaded from across the network onto the computer for streaming transfer to the audio system. The audio system can be equipped with an analog stereo input jack; e.g. a home stereo with a “LINE” or “AUX” jack. The user can listen to personal computer PC based MP3's and Internet with the wireless transmitter and receiver sending crystal clear digital audio from the PC to the audio system. The remote control feature allows a user to surf a collection of audio files from another location away from the PC.

1. Apparatus, comprising:
reception circuit including a frequency synthesizer;
a decoder for digitally demodulating an audio file signal from said reception circuit; and
a processor for initializing said decoder in response to a loss of a phase lock in said demodulating of said audio file signal and setting said frequency synthesizer at one of a plurality of frequencies to re-establish said phase lock in said demodulating of said audio file signal.

2. The apparatus of claim 1, wherein said plurality of frequencies comprise 900 MHz range channel frequencies.

3. The apparatus of claim 2, wherein said plurality of frequencies comprises 905 MHz, 911 MHz, 917 MHz and 923 MHz.

4. The apparatus of claim 1, wherein said decoder comprises an eight-to-four modulation EFM digital decoder.

5. The apparatus of claim 1, wherein said demodulating said audio file signal provides a digital audio stream conforming to an I2S audio format.

6. The apparatus of claim 1, wherein said processor is a microprocessor

7. A computer readable medium containing software instructions that, when executed by a processor, performs the steps of:
receiving a modulated audio file signal;
demodulating said audio file signal to a digital audio stream;
re-initializing said demodulating in response to a loss of a phase lock in said demodulating said audio file signal; and
setting said receiving at one of a plurality of channel frequencies to establish said phase lock in said demodulating.

8. The computer readable medium of claim 7, wherein said demodulating comprises a digital eight-to-fourteen modulation EFM digital decoding of said audio file signal.

9. The computer readable medium of claim 7, wherein said plurality of frequencies comprise 905 MHz, 911 MHz, 917 MHz and 923 MHz.

10. The computer readable medium of claim 7, wherein said demodulating outputs a digital audio stream.

11. The computer readable medium of claim 7, wherein said re-initializing and setting is carried out by a processor.

12. A communications system comprising:
a remote control reception circuit;
a streaming controller coupled to said remote control reception circuit;
an encoder for converting digital audio from said controller to a modulated data signal;
a transmission circuit for transmitting said modulated data signal at one of a plurality of channel frequencies selected in response to said remote control reception circuit;
reception circuit including a frequency synthesizer for receiving said modulated data signal;
a demodulator coupled to said receiver for demodulating said modulated data signal; and
a processor for initializing said demodulator in response to a loss of a phase lock in said demodulating of said modulated data signal and setting said frequency synthesizer at said one of a plurality of channel frequencies until said phase lock in said demodulating is established.

13. The system of claim 12, wherein said plurality of channel frequencies comprise 900 MHz range channels.

14. The system of claim 12, wherein said plurality of channel frequencies comprise 905 MHz, 911 MHz, 917 MHz and 923 MHz.

15. The system of claim 12, wherein said modulating comprises an eight-to-fourteen modulation EFM digital encoding.

16. The system of claim 12, wherein said demodulation comprises a digital eight-to-fourteen modulation EFM digital decoding.

17. The system of claim 12, wherein said transmitter and said receiver are synchronized to said one of a plurality of channel frequencies in the 900 MHz range.

18. The system of claim 12, wherein said receiver sequences through said plurality of channel frequencies until a phase lock loop is established in a phase lock loop in said demodulating said modulated data signal.

19. An apparatus comprising:
a streaming controller for providing digital audio;
an encoder for converting said digital audio to a modulated data signal; and
a transmission circuit for transmitting said modulated data signal at one of a plurality of channel frequencies, said transmission circuit being coupled to said encoder and said streaming controller.

20. The apparatus of claim 19, further comprising a remote control reception circuit coupled to said controller.
